(19) United States
(12) Patent Application Publication
(10) Pub. No.: US 2018/0364907 A1
(43) Pub. Date: Dec. 20, 2018

(54) A SYSTEM AND METHOD FOR DETECTING KEYSTROKES IN A PASSIVE KEYBOARD IN MOBILE DEVICES

(71) Applicant: SMARTRON INDIA PRIVATE LIMITED, Hyderabad (IN)

(72) Inventor: SHRENIK SARJERAO SHIKHARE, Kolhapur (IN)

(21) Appl. No.: 16/061,096

(22) PCT Filed: Dec. 8, 2016
(86) PCT No.: PCT/IN2016/000287

§ 371 Date: Jun. 11, 2018

(30) Foreign Application Priority Data
Dec. 9, 2015 (IN) 4773/CHE/2015

(51) Int. Cl. G06F 3/0488; G06F 3/043

(52) U.S. Cl. CPC G06F 3/04886; G06F 3/043

(57) ABSTRACT

The embodiments herein provide a passive keyboard system that allows a user to enter a text into a mobile device by tapping the passive keyboard surface. The system comprises a passive keyboard, a microphone array, and a processor. The microphone array detects the audio levels of keystrokes created by the user while tapping the passive keyboard surface and sends the detected audio levels to the processor. The processor maps the detected audio levels to a standard keyboard audio typing pattern to determine the keys pressed by the user. The processor generates key-events corresponding to the keys pressed and sends the key-events to an operating system of the mobile device. The OS forwards the key-events to an internal keyboard system which displays text on the mobile screen.

### CROSS-REFERENCE TO RELATED APPLICATION

This patent application is a National Phase Application corresponding to the PCT Application No. PCT/IN2016/000287 filed on Dec. 8, 2016 with the title “A SYSTEM AND METHOD FOR DETECTING KEYSTROKES IN A PASSIVE KEYBOARD IN MOBILE DEVICES”. This patent application claims the priority of the Indian Provisional Patent Application No. 4773/CHE/2015 filed on Dec. 9, 2015 with the title “A SYSTEM AND METHOD FOR DETECTING KEYSTROKES IN A PASSIVE KEYBOARD IN MOBILE DEVICES”, the contents of which is included herein by the way of reference.

### BACKGROUND

### Technical Field

The embodiments herein are generally related to mobile communication devices. The embodiments herein are particularly related to an input device for mobile communication devices. The embodiments herein are more particularly related to a virtual keyboard or a passive keyboard system for mobile communication devices. The embodiments herein are especially related to a system and method for detecting keystrokes in the passive keyboard using audio levels.

### Description of the Related Art

Mobile communication devices, such as smart phones, tablets are commonly used in different environments due to their portable nature. In general, these devices provide a virtual keyboard on a touch screen. The virtual keyboards, alternatively known as onscreen keyboards, provide a way for a user to bypass the traditional keyboards in entering the texts and inputs. The touch screens are capable of displaying a full size virtual keyboard that are similar to an external standard keyboard.

In the existing virtual keyboard designs, a plurality of technologies is used to detect a touch input. The most popular technologies include a capacitive and a resistive touch detection technology. In the resistive touch technology, the glass panel is coated with multiple conductive layers that register the touches when a physical pressure is applied to the layers. In the capacitive touch technology, the glass panel is coated with material that holds an electrical charge sensitive to a human finger. Further, a touch location is determined by detecting the change in the electrical charge due to the touch inputs. However the glass screen is to be coated with a material that reduces the clarity of the glass screen for implementing the resistive and capacitive touch detection technologies on the touch screen. Also the manufacturing cost and the component cost are expensive when larger screens are desired.

Device portability has driven a general trend towards a smaller sized mobile communication devices. In most of the designs, the size and key arrangement of the virtual keyboards do not match with the size of the user's hand because of the limited and fixed size of device screens. Thus, the device size limits the space available for implementing a full size virtual keyboard that is similar to an external standard keyboard.

Hence there is a need for a system and method for detecting the keystrokes of a passive keyboard using the audio levels of the keystrokes. There is also a need for an external passive keyboard system that allows a user to easily enter text into a mobile device by tapping on the surface of the passive keyboard. Further, there is also a need for a system and method for detecting the keystrokes in a low cost keyboard at the mobile devices by detecting the keystrokes based on the audio levels emanated by the keyboard surface.

The above mentioned shortcomings, disadvantages and problems are addressed herein and which will be understood by reading and studying the following specification.

### Objects of the Embodiments Herein

The primary object of the embodiments herein is to provide a system and method for detecting the keystrokes of a passive keyboard using audio levels of the keystrokes.

Another object of the embodiments herein is to provide a passive keyboard system that allows a user to easily enter text into a mobile device by tapping on the surface of the passive keyboard.

Yet another object of the embodiments herein is to provide a low cost keyboard to the mobile devices and to detect the keystrokes based on the audio levels emanated by the passive keyboard surface.

Yet another object of the embodiments herein is to convert any solid surface in to a virtual keyboard thereby avoiding a need to carry a physical keyboard.

Yet another object of the embodiments herein is to provide larger surface area for typing and the ease of experience of traditional keyboard, virtually.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The embodiments herein provide a passive keyboard system for entering text into a mobile device by tapping on the surface of the passive keyboard. The system comprises a passive keyboard placed external to the mobile device and comprising a standard keyboard layout configured for guiding a user to locate specific keys on the passive keyboard. The system also comprises an array of microphones set up inside the mobile device and configured for detecting the keystroke audio levels created by the user while tapping on the surface of the passive keyboard. The system further comprises a processor set up inside the mobile device and configured for receiving audio levels of the keystrokes from the array of microphones. The said processor is configured for mapping the received audio levels of the keystrokes to a standard keyboard audio typing patterns for determining the keys being pressed by the user. The processor is loaded with an algorithm for mapping the received audio levels of the keystrokes to a standard keyboard audio typing patterns for determining the keys being pressed by the user.

According to one embodiment herein, the said processor is further configured for generating the key-events corresponding to the keys pressed and for sending the key-events to an operating system (OS) of the mobile device.

According to one embodiment herein, the processor comprises a digital signal processor that is configured for processing the received signal digitally.

According to one embodiment herein, the system is further configured for observing the audio levels of the keystrokes created by the user during a taping operation of a key on the surface of the passive keyboard for the first time. The observations are further used for training the system to recognize the keys being pressed by the user based on audio levels of the keystrokes.

According to one embodiment herein, the operating system is configured for forwarding the received key events to an internal keyboard system of the mobile device for displaying a text on the mobile screen.

According to one embodiment herein, the mobile device comprises a mobile or handheld PC, a tablet or smart phone, a feature phone, a smart watch and the like.

According to one embodiment herein, the virtual key surface is divided into a plurality of cells arranged in a plurality of grids. The sound levels in each cell at each grid is mapped and stored in a table. Each cell is mapped to a key in a keyboard. The table is stored in a memory in the communication device. The processor receives the audio levels from the microphone array to identify a key from the table based on the received audio level from the microphone array.

According to one embodiment herein, a computer implemented method comprising instructions stored on a non-transitory computer readable storage medium and run on a computing device provided with a hardware processor and memory for detecting the keystrokes in a passive keyboard using the audio levels of the keystrokes is provided. The method comprises the steps of entering a text into a mobile device by tapping on a passive keyboard surface which is provided external to the mobile device. The method also comprises detecting the audio levels of the keystrokes created by the user while tapping on the surface of the passive keyboard using an array of microphones. The method further comprises receiving the detected audio levels of the keystrokes from the array of microphones and mapping the received audio levels of the keystroke to the standard keyboard audio typing patterns for determining the keys being pressed by the user using a processor and generating the key-events corresponding to the keys being pressed and sending the key-events to an Operating System (OS) of the mobile device.

According to one embodiment herein, the method further comprises forwarding the key-events to an internal keyboard system of the mobile device for displaying the text on the mobile screen.

According to one embodiment herein, the virtual key surface is divided into a plurality of cells arranged in a plurality of grids. The sound levels in each cell at each grid is mapped and stored in a table. Each cell is mapped to a key in a keyboard. The table is stored in a memory in the communication device. The processor receives the audio levels from the microphone array to identify a key from the table based on the received audio level from the microphone array.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1 illustrates a functional block diagram of a passive keyboard system for a mobile device, according to an embodiment herein.

FIG. 2 illustrates a flow chart explaining a method for detecting keystrokes in a passive keyboard using audio levels of the keystrokes, according to an embodiment herein.

Although the specific features of the present invention are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The embodiments herein provide a passive keyboard system for entering text into a mobile device by tapping on the surface of the passive keyboard. The system comprises a passive keyboard placed external to the mobile device and comprising a standard keyboard layout configured for guiding a user to locate specific keys on the passive keyboard. The system also comprises an array of microphones set up inside the mobile device and configured for detecting the keystroke audio levels created by the user while tapping on the surface of the passive keyboard. The system further comprises a processor set up inside the mobile device and configured for receiving audio levels of the keystrokes from the array of microphones. The said processor is configured for mapping the received audio levels of the keystrokes to a standard keyboard audio typing patterns for determining the keys being pressed by the user. The processor is loaded with an algorithm or mapping the received audio levels of the keystrokes to a standard keyboard audio typing patterns for determining the keys being pressed by the user.

According to one embodiment herein, the said processor is further configured for generating the key-events corresponding to the keys pressed and for sending the key-events to an operating system (OS) of the mobile device.

According to one embodiment herein, the processor comprises a digital signal processor that is configured for processing the received signal digitally.

According to one embodiment herein, the system is further configured for observing the audio levels of the keystrokes created by the user during a taping operation of a key on the surface of the passive keyboard for the first time. The observations are further used for training the system to recognize the keys being pressed by the user based on audio levels of the keystrokes.

According to one embodiment herein, the operating system is configured for forwarding the received key events to an internal keyboard system of the mobile device for displaying a text on the mobile screen.

According to one embodiment herein, the mobile device comprises a mobile or handheld PC, a tablet or smart phone, a feature phone, a smart watch and the like.

According to one embodiment herein, the virtual key surface is divided into a plurality of cells arranged in a plurality of grids. The sound levels in each cell at each grid is mapped and stored in a table. Each cell is mapped to a key in a keyboard. The table is stored in a memory in the communication device. The processor receives the audio levels from the microphone array to identify a key from the table based on the received audio level from the microphone array.

According to one embodiment herein, a computer implemented method comprising instructions stored on a non-transitory computer readable storage medium and run on a computing device provided with a hardware processor and memory for detecting the keystrokes in a passive keyboard using the audio levels of the keystrokes is provided. The method comprises the steps of entering a text into a mobile device by tapping on a passive keyboard surface which is provided external to the mobile device. The method also comprises detecting the audio levels of the keystrokes created by the user while tapping on the surface of the passive keyboard using an array of microphones. The method further comprises receiving the detected audio levels of the keystrokes from the array of microphones and mapping the received audio levels of the keystroke to the standard keyboard audio typing patterns for determining the keys being pressed by the user using a processor and generating the key-events corresponding to the keys being pressed and sending the key-events to an Operating System (OS) of the mobile device.

According to one embodiment herein, the method further comprises forwarding the key-events to an internal keyboard system of the mobile device for displaying the text on the mobile screen.

According to one embodiment herein, the virtual key surface is divided into a plurality of cells arranged in a plurality of grids. The sound levels in each cell at each grid is mapped and stored in a table. Each cell is mapped to a key in a keyboard. The table is stored in a memory in the communication device. The processor receives the audio levels from the microphone array to identify a key from the table based on the received audio level from the microphone array.

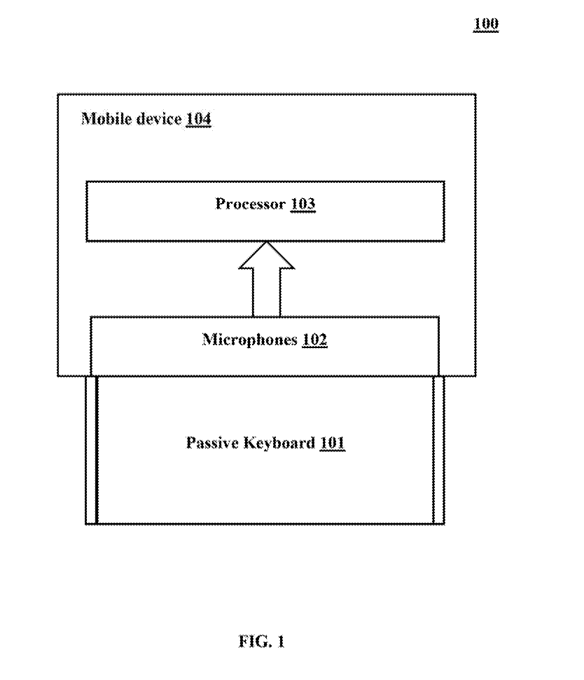

FIG. 1 illustrates a functional block diagram of a passive keyboard system for a mobile device, according to one embodiment herein. With respect to FIG. 1, the system 100 comprises a passive keyboard 101, an array of microphones 102 and a processor 103. The array of microphones 102 and the processor 103 are arranged inside the mobile device 104 of the user. The passive keyboard 101 is placed external to the mobile device 104.

According to one embodiment herein, the mobile device 104 is a mobile or handheld PC, or a tablet or smart phone, or a feature phone, or a smart watch, or any other similar device.

According to one embodiment herein, the surface of the passive keyboard 101 comprises a standard keyboard layout that guides the user to locate the specific keys on the passive keyboard 101. Here, passive keyboard 101 is a solid surface which has a keyboard layout drawn over it. Thus, any flat solid surface can be converted to a virtual keyboard by running a calibration method for each specific surface in order to get correct inputs. For example, the user of the mobile device 104 provides inputs with ‘finger tapping’ on the keyboard surface such as a table top.

According to one embodiment herein, the array of microphones 102 are configured to detect the audio levels of the keystrokes created by the user while tapping on the surface of the passive keyboard 101. For this purpose the passive keyboard has to be kept as close as possible to that of the microphone array present on the handheld mobile device. Thus, wired connectivity is not needed for establishing the connection. The array of microphones 102 are further configured to send the audio levels of the keystrokes to the processor 103.

According to one embodiment herein, the processor 103 is configured to receive the detected audio levels of the keystrokes from the array of microphones 102. The processor 103 is configured to map the received audio levels of the keystrokes to the standard keyboard audio typing patterns to determine the keys being pressed by the user. Each keystroke provides different profile of sound generated with keystroke which is analyzed and mapped to a correct corresponding key. The processor 103 is also configured to generate the key-events corresponding to the keys being pressed and to send the key-events to an Operating System (OS) of the mobile device 104.

According to one embodiment herein, the processor 103 is a digital signal processor that digitally processes the received signals.

According to one embodiment herein, the system 100 is configured to observe the audio levels of the keystrokes created by the user while tapping a key on the surface of the passive keyboard 101 for the first time. Later, the observations are used to train the system 100 such that the system 100 recognizes the keys being pressed by the user based on the audio levels of the keystrokes. Thus the system 100 is adapted to follow a specific keyboard typing pattern of the user.

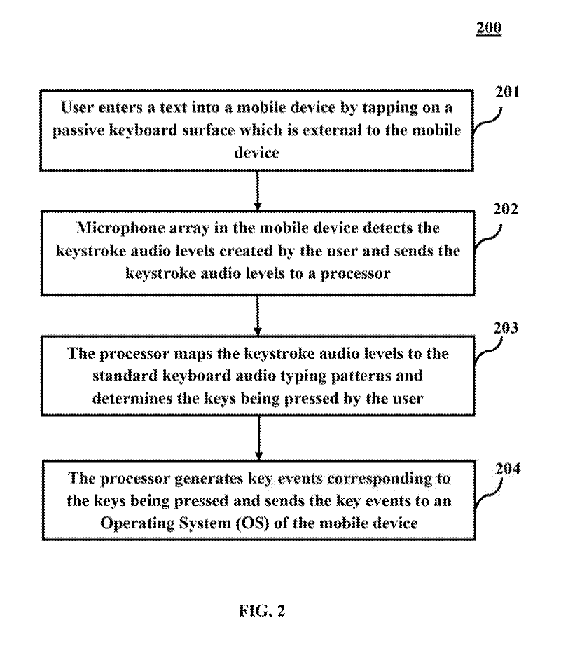

FIG. 2 illustrates a flow chart explaining a method for detecting the keystrokes in a passive keyboard using the audio levels of the keystrokes, according to one embodiment herein. The user enters a text into a mobile device by tapping on a passive keyboard surface which is provided external to the mobile device (201). The passive keyboard provides a standard keyboard layout that guides the user to locate the specific keys on the keyboard. An array of microphones arranged in the mobile device detects the audio levels of the keystrokes created by the user while tapping on the surface of the passive keyboard. The array of microphones sends the detected audio levels of the keystrokes to a processor (202). The processor receives the detected audio levels of the keystrokes from the array of microphones. Further, the processor maps the detected and received audio levels of the keystroke to the standard keyboard audio typing patterns to determine the keys being pressed by the user (203). Furthermore, the processor generates the key-events corresponding to the keys being pressed and sends the key-events to an Operating System (OS) of the mobile device (204). The OS forwards the key-events to an internal keyboard system of the mobile device which displays the text on the mobile screen.

Therefore, the embodiments herein provide a low cost passive keyboard system for mobile devices to allow a user to easily enter a text into the mobile device by tapping on the surface of the passive keyboard. The system achieves a full sized virtual keyboard for mobile devices that is similar to an external standard keyboard. Hence, the arrangement of keys on the keyboard matches with the size of the user's hand.

The system enables conversion of any solid surface in to a virtual keyboard thereby avoiding a need to carry a physical keyboard. Additionally user is facilitated with larger surface area for typing and the ease of experience of traditional keyboard virtually.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be the to fall there between.

What is claimed is:

1. A passive keyboard system for entering text into a mobile device, the system comprising:
a passive keyboard placed external to the mobile device and comprising a standard keyboard layout configured for guiding a user to locate specific keys on the passive keyboard;
an array of microphones set up inside the mobile device and configured for detecting the keystroke audio levels created by the user while tapping on the surface of the passive keyboard; and
a processor in the mobile device configured for receiving audio levels of the keystrokes from the array of microphones, and wherein the processor is configured for mapping the received audio levels of the keystrokes to a standard keyboard audio typing patterns for determining the keys being pressed by the user, and wherein the processor is loaded with an algorithm for mapping the received audio levels of the keystrokes to a standard keyboard audio typing patterns for determining the keys being pressed by the user.

2. The system according to claim 1, wherein the processor is further configured for generating the key-events corresponding to the keys pressed and for sending the key-events to an operating system (OS) of the mobile device.

3. The system according to claim 1, wherein the processor comprises a digital signal processor that is configured for processing the received signal digitally.

4. The system according to claim 1, wherein the system is further configured for observing the audio levels of the keystrokes created by the user during taping of a key on the surface of the passive keyboard for the first time; wherein the observed audio levels are further used for training the system to recognize the keys being pressed by the user based on audio levels of the keystrokes.

5. The system according to claim 1, wherein the OS is configured for forwarding the received key events to an internal keyboard system of the mobile device for displaying a text on the mobile screen.

6. The system according to claim 1, wherein the mobile device is selected from a group consisting of a mobile or handheld PC, a tablet or smart phone, a feature phone, a smart watch.

7. A computer implemented method comprising instructions stored on a non-transitory computer readable storage medium and run on a computing device provided with a hardware processor and memory for detecting the keystrokes in a passive keyboard using the audio levels of the keystrokes, the method comprising the steps of:
entering a text in a mobile device by tapping on a passive keyboard surface which is provided external to the mobile device;
detecting the audio levels of the keystrokes created by the user while tapping on the surface of the passive keyboard using an array of microphones;
receiving the detected audio levels of the keystrokes from the array of microphones and mapping the received audio levels of the keystroke to the standard keyboard audio typing patterns for determining the keys being pressed by the user using a processor; and
generating the key-events corresponding to the keys being pressed and sending the key-events to an Operating System (OS) of the mobile device.

8. The method according to claim 7, wherein the method further comprises the step of forwarding the key-events to an internal keyboard system of the mobile device for displaying the text on the mobile screen.

9. The method according to claim 7, wherein the method further comprises the step of loading the processor with an algorithm for mapping the received audio levels of the keystrokes to a standard keyboard audio typing patterns for determining the keys being pressed by the user.
